(19) United States
(12) Patent Application Publication
(10) Pub. No.: US 2004/0236591 A1
(43) Pub. Date: Nov. 25, 2004

(54) System and method for optimizing sourcing opportunity utilization policies

(76) Inventors: Blake Johnson, Del Mar, CA (US); Dario Benavides, Cupertino, CA (US); Heiko Pieper, Mountain View, CA (US); Colin Kessinger, Menlo Park, CA (US); Allan Gray, Los Altos, CA (US)

Correspondence Address: CARR & FERRELL LLP, 2200 GENG ROAD, PALO ALTO, CA, 94303, US

(21) Appl. No.: 10/621,726

(22) Filed: Jul. 17, 2003

Related U.S. Application Data
(63) Continuation-in-part of application No. 10/269,794, filed on Oct. 11, 2002.
(60) Provisional application No. 60/396,890, filed on Jul. 17, 2002.

(51) Int. Cl. G06F 17/60

(52) U.S. Cl. 705/1

(57) ABSTRACT

A system and method is provided for optimizing sourcing opportunity utilization policies. A user provides at least one of a business objective and a business constraint. Next, an available set of sourcing opportunity utilization policies is determined. From this set, an “optimal” sourcing opportunity utilization policy is selected based on its ability to best meet the at least one business objective or constraint. Based on evaluation of the optimal sourcing opportunity utilization policy and/or associated business performance, the at least one business objective or constraint and/or available set of sourcing opportunity utilization policies may be revised, and the process repeated to determine the optimal sourcing utilization policy for this revised specification.

### CROSS-REFERENCE TO RELATED APPLICATIONS

This application is a continuation-in-part application of U.S. patent application Ser. No. 10/269,794 filed on Oct. 11, 2002 entitled “System and Method for Automated Analysis of Sourcing Agreements and Performance,” which is hereby incorporated by reference. This application also claims priority and benefit of U.S. Provisional Patent Application Serial No. 60/396,890 entitled “System and Method for Identifying Sourcing Opportunity Utilization Policies,” filed on Jul. 17, 2002, which is also hereby incorporated by reference.

### BACKGROUND OF THE INVENTION

1. Field of the Invention

The present invention relates generally to sourcing of materials and services, and more particularly, to a system and method for optimizing policies for utilizing available sourcing opportunities to best meet business objectives and constraints.

2. Description of Related Art

Proper management of material and service sourcing is a huge challenge to virtually every business. Typically, the cost of sourcing materials and services comprise 30-70% of revenue and drives a business' gross margin. Uncertain demand and supply of materials and services make future cost, availability, and liability difficult to predict and manage. As a consequence, many of the primary measures of a firm's operational and financial performance, such as customer service levels, inventories, costs, revenue, and margins, are difficult to predict or control, as are the firm's desired trade-offs between business objectives for performance across these multiple dimensions of performance, including their respective risk levels.

For example, higher service levels can often be ensured by incurring higher cost, but the ability to predict and manage this trade-off to best achieve management's specific business objectives and constraints for services levels and cost, given the sourcing opportunities available to the business over time, is difficult. Similarly, it may be possible to reduce inventory costs and risks by securing greater flexibility of supply or shorter supply lead times, typically in exchange for a higher cost of supply. However, it is difficult to accurately predict and manage performance on these and related dimensions of sourcing performance through efficient utilization of the sourcing opportunities available to the business.

More generally, businesses lack an ability to ensure that they optimally utilize available sourcing opportunities to best meet specific business objectives and constraints for cost, availability, liability, and other key business performance metrics. Because of the important role effective sourcing plays in successful business performance, an ability to manage sourcing to best meet a business' specific performance objectives related to a material(s) and service(s) would be extremely valuable. As noted above, accomplishing this is made difficult by many dimensions of business performance that are affected by sourcing, and by many complex interactions and trade-offs between these dimensions of performance.

Additional difficulty results from a wide range of prospective sourcing actions that a business may take over time and across potential future circumstances, each of which impact performance and performance trade-offs. For example, in most instances, available sourcing opportunities include decisions concerning a number and type of supply agreements or other supply opportunities that should be established and maintained over time, suppliers from with which these agreements or supply opportunities should be established with, and how these and other sources of supply that may be available (e.g., spot markets, brokers, distributors, and other supply alternatives) should be utilized over time and across a range of circumstances that may occur over time.

One method for reducing sourcing uncertainty is for a business to develop and follow a sourcing opportunity utilization policy (“SOUP”), which is a particular policy or strategy for selecting and utilizing a set of sourcing opportunities that may be available over time and across potential future circumstances. Thus, an ability to determine the SOUP that best achieves specific business objectives and constraints is valuable.

However, determining the SOUP that best achieves specific business objectives and constraints is challenging. Further, a relationship between characteristics of a particular SOUP and many dimensions of sourcing performance that result from the particular SOUP are complex. Moreover, analyzing and understanding how specific aspects of the SOUP will impact specific dimensions of sourcing performance is difficult. In addition, understanding trade-offs and interactions between the many dimensions of the SOUP and how the SOUP jointly determines the many dimensions of sourcing performance is even more difficult to analyze and understand.

Therefore, there is a need for a system and method for optimizing sourcing opportunity utilization policies. There is a further need for this system and method to be relatively easy to operate.

### SUMMARY OF THE INVENTION

The present invention provides a system and method for identifying and optimizing a sourcing opportunity utilization policy. According to one method of the present invention, at least one business objective or constraint for business performance over time and across potential future circumstances is received from a user. Next, an available set of sourcing opportunity utilization policies is defined. This set is then utilized to perform a series of sourcing performance analyses. Subsequently, an “optimal” sourcing opportunity utilization policy is determined based on its ability to best meet the at least one business objective or constraint. Based on evaluation of the optimal sourcing opportunity utilization policy and/or associated business performance, the at least one business objective or constraint and/or the available set of sourcing opportunity utilization policies may be revised, and the process repeated to determine the optimal sourcing utilization policy for this revised specification.

In an exemplary embodiment of the present invention, the system comprises a sourcing opportunity utilization policies engine. The sourcing opportunity utilization policies engine is configured to develop the set of available sourcing opportunity utilization policies.

The system further comprises an optimization engine which determines the optimal sourcing opportunity utilization policy. The optimization engine receives at least one objective for business performance over time and across potential future circumstances. Utilizing this at least one objective, the optimization engine reviews sourcing performance results based on the set of available sourcing opportunity utilization policies from the sourcing opportunity utilization policies engine to determine the one sourcing opportunity utilization policy which bests satisfies the at least one objective. The optimal sourcing opportunity utilization policy may also be revised as a result of changes in the available set of sourcing opportunity policies generated by the sourcing opportunity utilization policies engine and/or in the at least one objective for business performance over time and across potential future circumstances.

A further understanding of the nature and advantages of the inventions herein may be realized by reference to the remaining portions of the specification and the attached drawings.

### BRIEF DESCRIPTION OF THE DRAWINGS

FIG. 1 is a high level overview diagram of the present invention for analysis of sourcing opportunity utilization policies and sourcing performance;

FIG. 2 is an exemplary block diagram of a sourcing opportunity utilization policy and sourcing and performance analysis system for implementing the present invention;

FIG. 3 is an exemplary block diagram of the cost/risk generator of FIG. 2;

FIG. 4 is a flowchart of an exemplary method for sourcing opportunity utilization policy and sourcing performance analysis by the cost/risk generator of FIG. 3;

FIG. 5 is a flowchart of an exemplary method for identifying a sourcing opportunity utilization policy which best meets a business' specific objectives in accordance with an embodiment of the present invention;

FIG. 6 is an exemplary flowchart of a method for defining a set of available sourcing opportunity utilization policies; and

FIG. 7 is an exemplary flowchart of a method for analytically representing a set of feasible sourcing opportunity utilization policies.

FIG. 8 is an exemplary embodiment for representing prospective sourcing alternatives in a building block approach using a submenu accessed through a high level menu.

FIG. 9 is an exemplary embodiment for representing prospective sourcing alternatives in a building block approach using high level menus.

### DESCRIPTION OF EXEMPLARY EMBODIMENTS

The present invention provides a system and method for identifying effective sourcing opportunities and their utilization policies, and for analyzing and comparing sourcing performance for given sets of sourcing opportunities and their utilization policies. The system and method may require tracking impact of past dealings and relationships over time in order to determine how past dealings may affect future sourcing opportunities and their utilization and future sourcing performance.

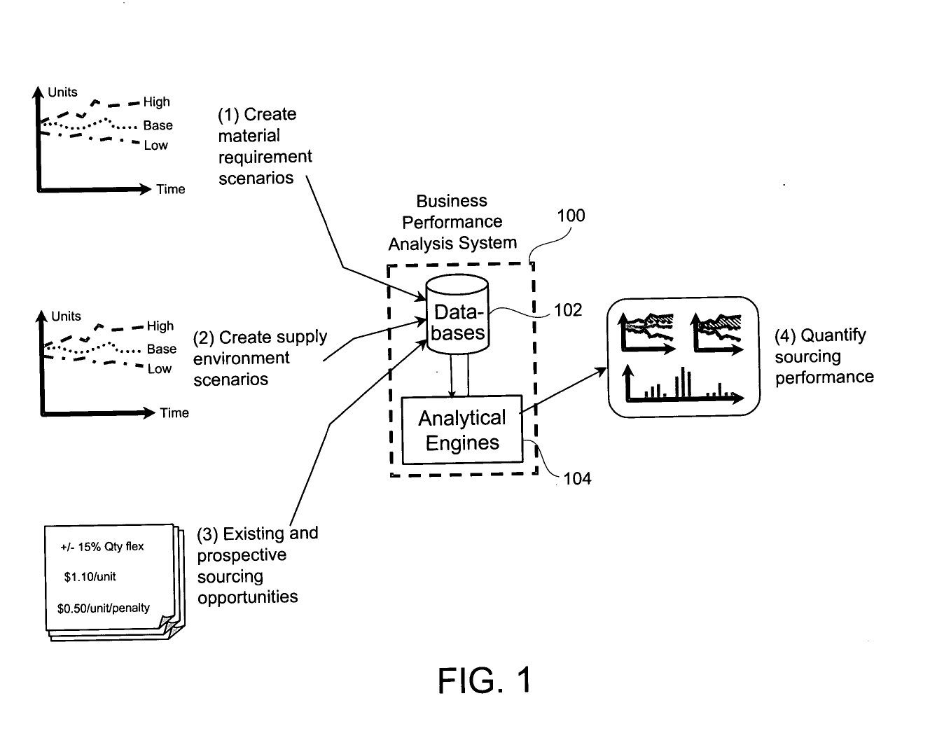

FIG. 1 is a high level overview diagram of the present invention for analysis of sourcing opportunity utilization policies and sourcing performance. As shown, various inputs are required to be entered into a business performance analysis system 100. The inputs include material requirement scenarios and supply environment scenarios and their relationships, storage cost and shortage cost information, which may also be specified by scenario, and existing and prospective sourcing agreements. These inputs may be entered into a database 102 or, alternatively, may be developed by analytical engines 104 within the business performance analysis system 100. Subsequently, the various analytical engines 104 of the business performance analysis system 100 take the numerous inputs and produce a result reflecting sourcing goals. Although specific inputs are provided, those skilled in the art will recognize that not all these inputs may be used or other inputs may be employed.

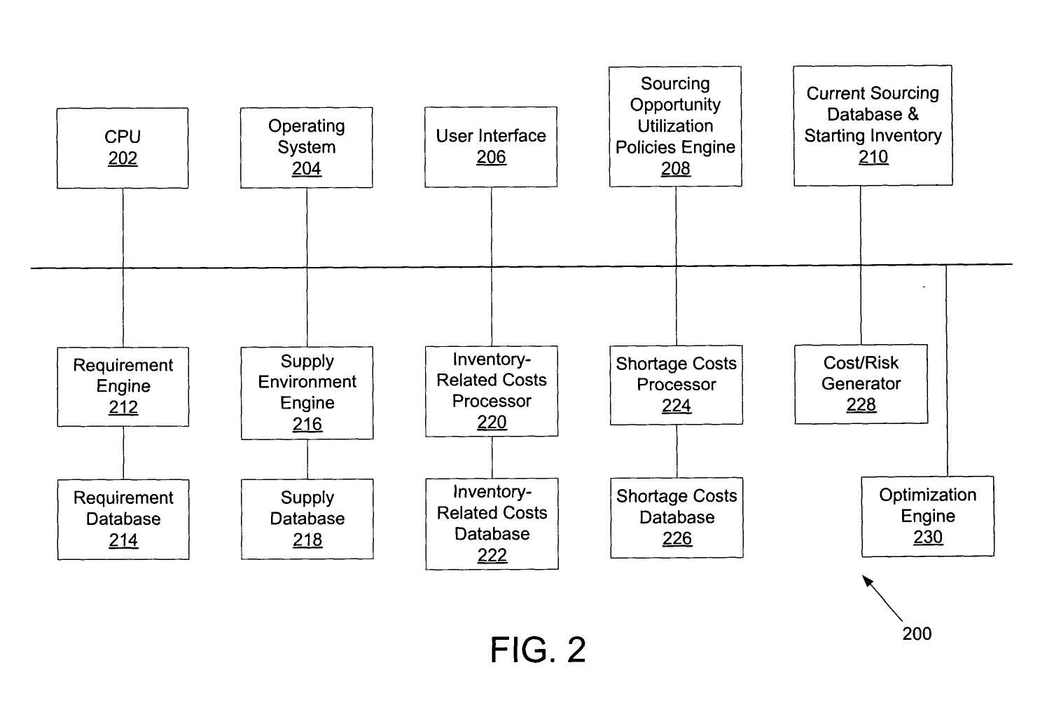

FIG. 2 is an exemplary block diagram of a business performance analysis system 200, according to the present invention. The analysis system 200 comprises a central processing unit (CPU) 202, an operating system 204, a user interface 206, sourcing opportunity utilization policies engine 208 (e.g., contract utilization policies engine or sourcing opportunity utilization policies engine), and a current source database and starting inventory 210. The analysis system 200 further comprises a requirement engine 212, a corresponding requirement database 214, a supply environment engine 216, a corresponding supply database 218, a storage costs processor 220, a corresponding storage costs database 222, a shortage cost processor 224, a corresponding shortage costs database 226, a cost/risk generator 228, and an optimization engine 230. In alternative embodiments, more or less processors, databases, or other elements may be coupled to the business performance analysis system 200.

The analysis system 200 takes various input information, formulates scenarios, and performs analyses of these scenarios to find at least one sourcing performance analysis result. The analysis system 200 relies on information and preferences input by the user in order to perform the analysis. The information and preferences are entered into the analysis system 200 through the user interface 206.

The sourcing opportunity utilization policies engine 208 contains rules or strategies which drive the analysis process of the present invention. In one embodiment, these strategies may be input by a user. For example, the user may require that the lowest material costs be the driving factor in the analysis process. Therefore, the sourcing opportunity utilization policies engine 208 will contain a lowest material costs requirement. In an alternative embodiment, the sourcing opportunity utilization policies engine 208 may derive sourcing opportunity utilization policies based on guidance from the user, such as minimization of material costs, risks, and storage costs over a certain period of time. Thus, if the user prefers reducing total sourcing costs or risks in the next year, the sourcing opportunity utilization policies engine 208 will generate sourcing opportunity utilization policies reflecting this preference. Other rules include, but are not limited to, minimizing inventory level, minimizing storage costs, reducing shortage levels, or reducing uncertainty about the future value of any such variables. If no guidance is given by the user, the sourcing opportunity utilization policies engine 208 may generate a series of generic sourcing opportunity utilization policies from which the user may choose. A particular policy or strategy for utilizing a set of such sourcing opportunities that may be available over time and across potential future circumstances will hereafter be referred to as a sourcing opportunity utilization policy (or “SOUP”).

Setting objectives in the sourcing opportunity utilization policies engine 208 may be difficult as tradeoffs must be made between different metrics and within particular metrics (e.g., between expected values and risks). For example, a tradeoff between different metrics may involve reducing inventory-related costs and reducing prices. Alternatively, an example of a tradeoff between expected value and risk may be between a reduced expected sourcing cost and increased predictability of sourcing cost. Ideally, a strategy that improves both metrics at the same time is desired. Although, a strategy that improves one metric without adversely affecting the other metric is also desirable. Additionally, these metrics can be used to identify potential future sourcing risk exposures such as inventory spikes or shortages, price spikes, or significant increases in overall sourcing costs.

Each SOUP from among a set of all prospective SOUPs for a material(s) or services(s) of interest will, in general, result in, and accordingly make possible, a different set of business performance consequences over time and across potential future circumstances (hereinafter “business performance over time and across circumstances” or “BPOTC”). Resultantly, different SOUPs impact BPOTC differently. For example, an opportunity to achieve a high service level by incurring higher costs may result from an opportunity to enter into a supply agreement that provides guaranteed availability of supply at short lead times in exchange for a higher purchase price. Alternatively, a high service level may also be achieved through a sourcing strategy that includes maintenance of significant inventory safety stocks over time. Thus in this example, a high service level may be achieved with two alternative SOUPs, each with very different consequences for a business' overall operating and financial performance measures over time. Consequently, under the first policy, the purchase price will be high, but inventory levels and risk will be low. In contrast, under the second policy, the purchase price may be low, but inventory levels, storage costs, and risk will be high.

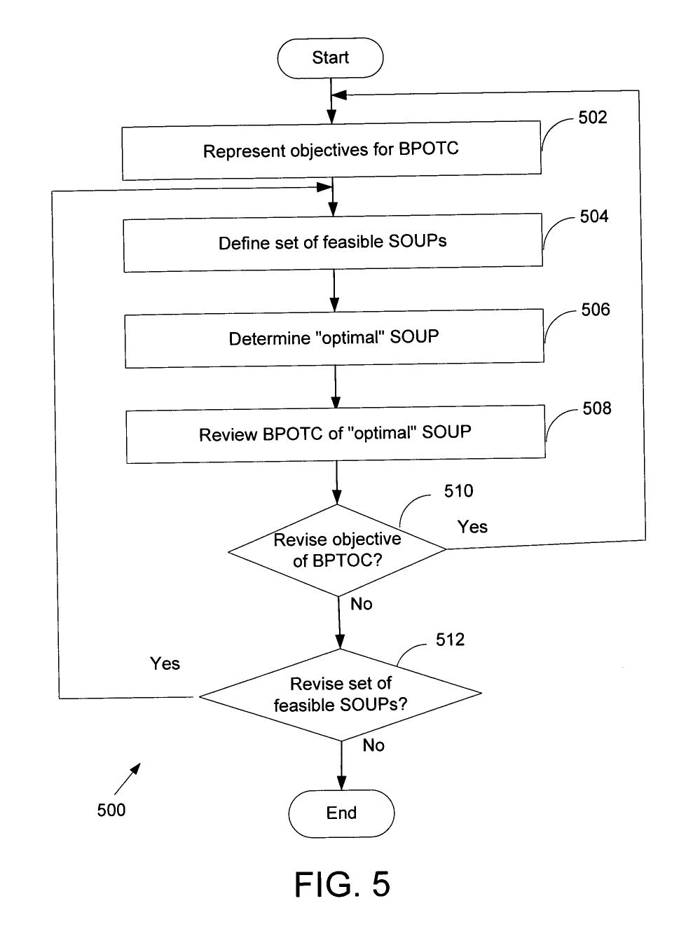

In order to optimize sourcing to best meet a business' specific objectives for BPOTC, performance impact of a full range of prospective SOUPs should be evaluated. In one embodiment of the present invention, these BPOTC objectives are input through the optimization engine 230. Subsequently, the SOUP that best meets the business' objectives for BPOTC, including desired levels of risk of, and trade-offs between, individual dimensions of sourcing performance for material(s) or service(s) in question must be identified. For example, a firm may wish to minimize expected material purchase price, subject to constraints that inventory levels remain below a maximum acceptable level and service levels remain above a minimum acceptable level with a specified probability. Alternatively, the firm may specify objectives for BPOTC to minimize expected total sourcing cost, including material, inventory, and shortage-related costs, while maintaining supply-related liabilities, including financial and operational commitments to suppliers and inventory risk exposures, below specified maximum levels with a 95% probability. The present invention provides a method for determining the SOUP for a material or service, or set of such materials or services, which best meets a business' specific objectives for BPOTC. The method will be discussed in more detail in connection with FIG. 5.

Current sourcing database and starting inventory 210 contains data regarding the status quo. The data include terms and conditions of existing sourcing opportunities and present inventory of materials, including materials currently on order but not yet received. Current sourcing data are vital to the analysis process because the current sourcing data have direct impact on an outcome of the analysis process. For example, if there is currently a large inventory, a lower need exists for purchasing materials in a near term. Thus, sourcing opportunities may be negotiated or utilized accordingly.

The various remaining engines and processors (i.e., requirement engine 212, supply environment engine 216, inventory related cost processor 220, and shortage cost processor 224) generate respective scenarios based on various inputs. These inputs may be provided directly by a user or, alternatively, be obtained from other data sources. For example, the requirement engine 212 takes inputs and generates possible material requirement scenarios based on a series of sequences of uncertain events over time.

The various remaining databases contain corresponding generated scenarios which will be utilized by the cost/risk generator 228 during the optimization process. Thus, the requirement database 214 comprises scenarios of material requirements at various future periods in time, while the supply environment database 218 comprises price and availability scenarios. Consequently, the storage cost database 222 holds storage cost scenarios, and the shortage cost database 226 stores shortage cost scenarios.

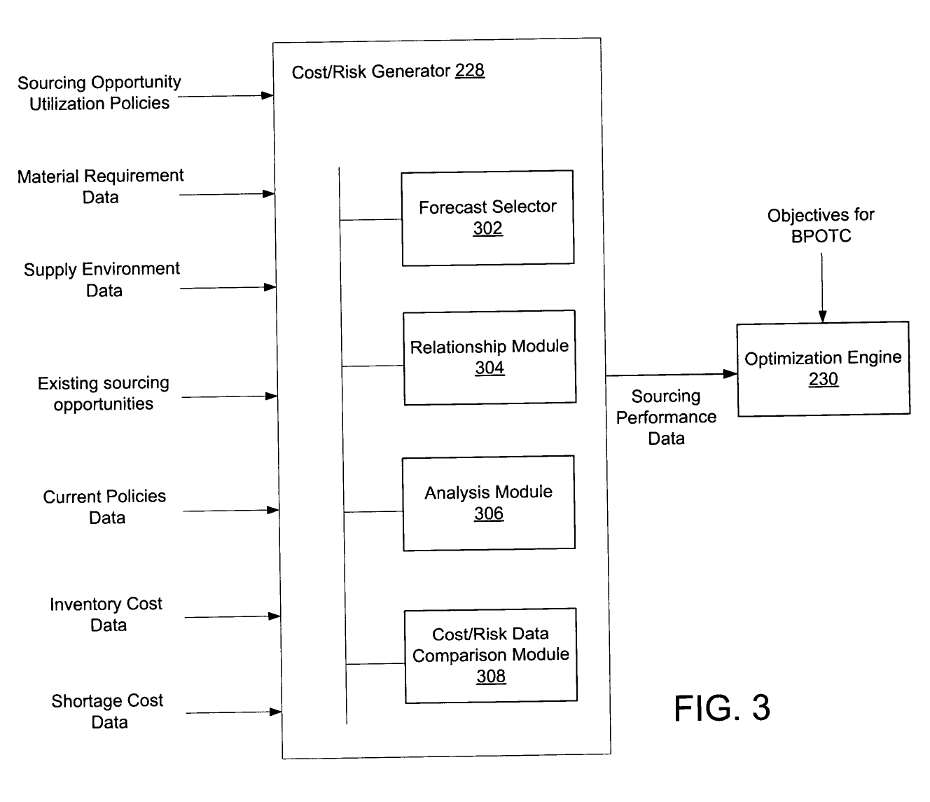

Once a SOUP and all required parameters and scenarios are present or generated, the cost/risk generator 228 performs the sourcing performance analysis. FIG. 3 is a block diagram of an exemplary cost/risk generator 228, according to the present invention. The cost/risk generator 228 includes a forecast selector 302, a relationship module 304, an analysis module 306 and a cost/risk data comparison module 308. Initially, the forecast selector 302 selects a material requirement forecast or scenario from the requirement scenarios stored in the requirement database 214 (FIG. 2) and a supply environment forecast or scenario from the supply database 218 (FIG. 2).

Next, the relationship module 304 creates a relationship between the material requirement data and the supply environment data. A probability of a material requirement/supply environment combination depends upon the relationship between material requirement and supply environment data. Material requirements and supply environment may be positively correlated, uncorrelated, or negatively correlated. For example, material requirements are typically positively correlated with the supply environment when a differentiation factor between material requirements scenarios is at a level of overall market growth and capacity is expensive and time consuming to build. Alternatively, material requirements are unrelated with supply environment when the differentiation factor between material requirement scenarios is at the level of market share, capacity is less expensive to build, or capacity lead-time is short. Finally, material requirements are negatively related with supply environment when higher company requirements are associated with lower overall market demand.

Once a relationship is created, the cost/risk generator 228 identifies existing sourcing opportunities from those stored in the current sourcing database and starting inventory 210 (FIG. 2). Subsequently, the analysis module 306 defines analysis assumptions based on storage cost parameters or scenarios from the storage database 222 (FIG. 2) and shortage cost parameters or scenarios from the shortage cost database 226 (FIG. 2).

The results of the relationship module 304 and the analysis module 306 are then forwarded to the cost/risk data comparison module 308. The appropriate SOUP from the sourcing opportunity utilization policies engine 208 (FIG. 2) is also transferred to the cost/risk data comparison module 308, which performs a sourcing performance analysis by computing future costs and risks for each material requirement and supply environment scenario combination. The cost/risk comparison module 308 reviews various metrics in evaluating impact on future business performance. These metrics may include shortage level, inventory position, price level, and sourcing agreement value. Thus, the cost/risk data comparison module 308 captures the relationship between a SOUP, material requirements, supply environment, storage costs, shortage costs and other input parameters and BPOTC.

Output from the cost/risk data comparison module 308, and subsequently the cost/risk generator 228, may be a plurality of reports presenting costs, risks, and other performance information per period for each possible outcome. Furthermore, reports may present cost, inventory, and availability information for multiple points of time and scenarios given the required parameters and sourcing opportunity utilization policies. According to one embodiment of the present invention, the output is directed to the optimization engine 230. The optimization engine 230 will then take the various outputs from the cost/risk generator 228 and compare the results to determine the optimal SOUP based on the business' objectives for BPOTC.

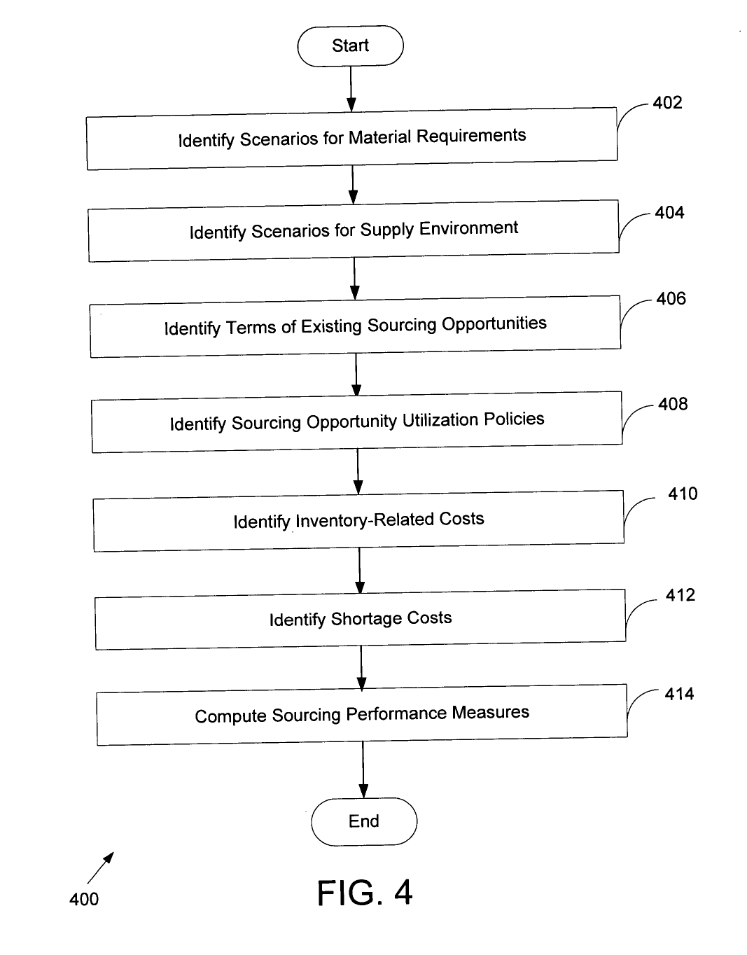

FIG. 4 is a flowchart 400 of an exemplary method for SOUP and sourcing performance analysis by the cost/risk generator 228 (FIG. 2). Initially in block 402, the cost/risk generator 228 identifies scenarios for material requirements. These scenarios are preferably developed by the requirement engine 212 (FIG. 2) based on user inputs and stored in the requirement database 214 (FIG. 2).

Next, scenarios for supply environment are identified in block 404. These supply environment scenarios are determined by the supply environment engine 216 (FIG. 2), and subsequently stored in the supply database 218 (FIG. 2). Alternatively, the supply environment scenarios may have been provided by the user and directly input to the supply database 218.

Subsequently, the cost/risk generator 228 then identifies terms of existing sourcing agreements and the current material inventory amount and material on order in block 406. The existing sourcing agreements are input by a user and stored in the current sourcing database and starting inventory 210 (FIG. 2). Current material inventory information is also initially provided by the user and stored in the current sourcing database and starting inventory 210.

Sourcing opportunity utilization policies (“SOUPs”) are then identified in block 408. These SOUPs may be provided by the user and stored in the sourcing opportunity utilization policies engine 208 (FIG. 2). Alternatively, SOUPs may be generated by the sourcing opportunity utilization policy engine 208.

Subsequently in blocks 410 and 412, the storage and shortage costs scenarios are identified. The storage and shortage costs may be input by the user into the analysis engine 200 (FIG. 2) and stored in the storage cost database 222 (FIG. 2) and shortage cost database 226 (FIG. 2), respectively. Alternatively, the storage cost scenarios may be calculated by storage cost processor 220 (FIG. 2) and stored in the storage cost database 222. Similarly, the shortage cost scenarios are determined by the shortage cost processor 224 (FIG. 2) and then stored in the shortage cost database 226.

Finally, the cost/risk generator 228 takes all the material requirement scenarios, supply environment scenarios, current sourcing agreements and inventory, storage cost, and shortage cost scenarios and computes BPOTC (as described in FIG. 3) based on the given SOUP in block 414. The output is a range of results including future inventory, material costs, storage costs and shortage costs over each future scenarios. The resulting cost and risk outputs provide guidance to the user as to the performance of a SOUP in different future scenarios given particular business goals. The output reports may analyze overall BPOTC, including cost performance, price performance, inventory performance, shortage performance, or any combination thereof, and be in the form of spreadsheets, graphs, charts, raw data, etc.

It should be noted that FIG. 4 provides an exemplary method for analysis of SOUPS and BPOTC. Alternatively, the identifying steps of the method may be performed in a different order. For example, the sourcing opportunity utilization policies may be identified after the storage and shortage costs have been identified. In yet further embodiments, more or less steps may be performed by the method. Further, alternative embodiments may utilize other scenarios or parameters (e.g., scenarios or parameters in addition to those described above), fewer scenarios or parameters, more scenarios or parameters, or different combinations of scenarios or parameters.

The range of outputs provides guidance to the user as to future circumstances based on implementation and utilization of certain SOUPs. The user must ultimately decide given the various outputs which SOUP is best for the business, given objectives for BPOTC. For example, the output of the cost/risk generator 228 may include two options. Option A may have 4% material shortage, an average of 90 days of inventory, and $0.90 component price per unit resulting in a total sourcing cost of $17.6 million per year. Alternatively, option B may have 3% material shortage, an average of 60 days of inventory, and a component price of $1.00 per unit resulting in a total sourcing cost of $17.8 million per year. If the business' objective is to reduce total sourcing costs and there are no other constraints or risk management objectives, then option A ($17.6 million total cost) would be the proper choice. However, given the same objective, but with a constraint of keeping inventory at 60 days or less, then the business should choose option B ($17.8 million total cost).

The present invention can provide a range of results for designing and selecting SOUPs. Additionally, the present invention may generate an optimized SOUP based on user-input objectives for BPOTC. Therefore, given a set of specific objectives for BPOTC, the analysis engine 200 will determine which sourcing opportunities or set of sourcing opportunities should be employed in order to meet the business goals, and how those sourcing opportunities should be optimally utilized over time and across prospective future circumstances.

Referring now to FIG. 5, a flowchart 500 of an exemplary method for identifying a SOUP which best meets a business' specific objectives for BPOTC is shown. In step 502, a business' objectives for a BPOTC related to material(s) and service(s) is represented. In one embodiment, a user provides business objectives and constraints to the system. For example, the user may set forth the business objective and/or constraint of minimizing sourcing-related costs. The user's input may include a business objective that is also a constraint, vice versa, or either a business objective or a business constraint. Further, a business objective and/or a business constraint may include objectives and/or constraints as subsets thereof. For instance, the minimizing sourcing-related costs business objective and/or constraint may further include the business objective of minimizing sourcing-related liabilities, etc.

The user may carefully draft objectives for BPOTC, tailoring the objectives for BPOTC to the specific business, goals, etc. The objectives for BPOTC may be specified in terms of a small number of high level performance objectives and constraints, a large number of high level performance objectives and constraints, a large number of low level performance objectives and constraints, etc. In other words, the user may be as broad or as narrow as desired in crafting or selecting business objectives and constraints. As an alternative, the user may choose business objectives and constraints from a list of business objectives and constraints provided to the user, such as in a menu. Further, the list may be expanded by adding business objectives and constraints drafted by previous users.

A business' objectives for BPOTC may be derived from a combination of high level objectives for its overall business as well as more specific and tailored objectives for comparable metrics for specific business units or product lines that utilize the material(s) or service(s), and objectives for specific material(s) and service(s), themselves. The high level objectives may comprise, for example, revenue, profit margin, market share, customer service levels, inventory levels, and risk exposure. Objectives for specific material(s) and service(s) may comprise, for example, number and type of sources of supply, characteristics of suppliers, purchase price, service levels, and inventory. For example, a business may wish to restrict the type and/or amount of financial liability or liability for raw materials held by one or more suppliers which it assumes. Alternatively, it may wish to restrict the portion of its purchases made from individual suppliers or categories of suppliers, such as suppliers of a certain size or from a particular geographic region, or its purchases under specific types of delivery arrangements, such as “expedited” delivery terms.

A business' objectives for BPOTC related to these performance objectives may comprise historical, current, and/or future values of one or more of these measures or functions. In general, the specification or representation of a business' objectives for BPOTC will incorporate a number of performance measures, as well as relationships between measures. In one embodiment, because future values of performance measures are in most cases uncertain due to uncertainty about future events, objectives may be specified in terms of a probability distribution of one or more measures at one or more points in time, as well as sequences or cumulative values of such measures over periods of time.

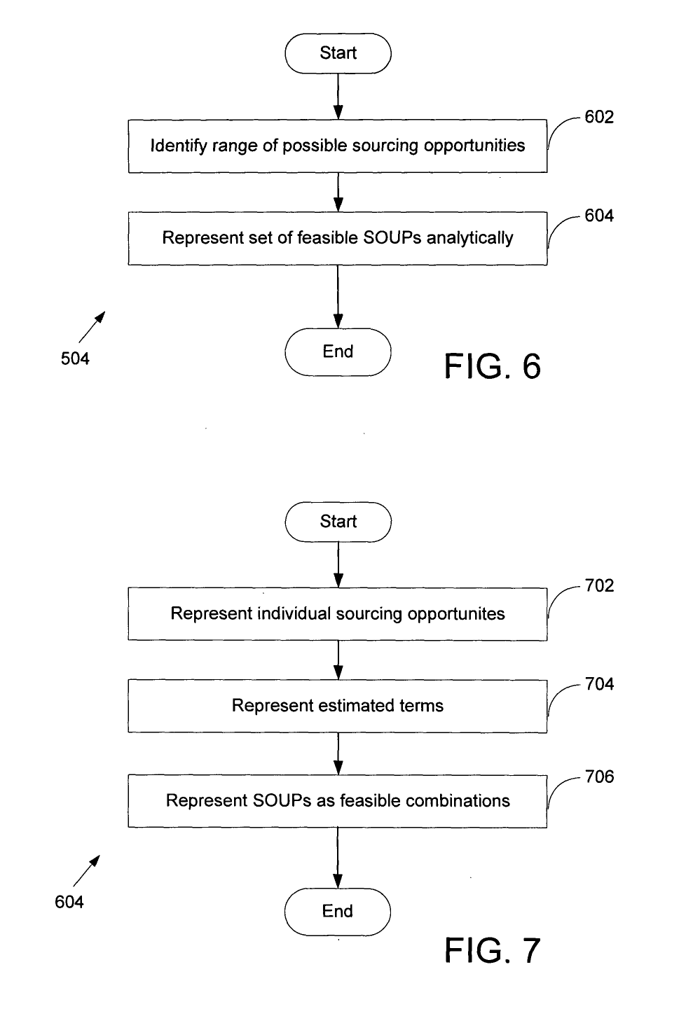

In step 504, a set of feasible sourcing opportunity utilization policies (“SOUP”) available to a business for the material(s) and service(s) in question is defined by the sourcing opportunity utilization policy engine 208. The set of feasible SOUPs may comprise terms, utilization alternatives, projected supplier performance under both existing and potential supply relationships and agreements, and other sources of supply that may be available, such as spot markets, brokers, distributors, etc. Step 504 will be discussed in more detail in connection with FIG. 6.

Subsequently in step 506, the SOUP that will best achieve the business' objective for BPOTC as defined by step 502 is identified. The “optimal” SOUP is determined by solving the optimization problem defined by the objective function, constraints (i.e., objectives for BPOTC), and set of feasible solutions (i.e., feasible SOUPs) identified in steps 502 and 504. The BPOTC that will result if a specific SOUP is followed is determined by utilizing the system of FIG. 3, the method of FIG. 4, or any other similar system or method. Thus, the “optimal” SOUP may be identified using any one of a number of existing optimization or search methods. A range of established optimization methods can be employed to optimize this result. Since in most cases one or more aspects of a future supply and/or demand of the relevant material(s) or service(s) are uncertain, stochastic optimization methods may need to be utilized.

There may be situations where issues are identified in a specification of the optimization problem as defined by the objectives for BPOTC specified in step 502 and set of feasible SOUPs defined in step 504. For example, no feasible solutions may exist to the problem as specified, or a solution is degenerate or unbounded. In these situations, steps 508-512 allows for modification or refinement of the objectives and set of feasible SOUPs, as appropriate, to address these and other formulation-related issues.

In step 508, results of the optimization performed in step 506 are evaluated (i.e., BPOTC based on the “optimal” SOUP is evaluated). If the user finds unintended, or undesirable, BPOTC on one or more dimensions, the user may revise any input (e.g., objectives for BPOTC, set of feasible SOUPs, etc.). The set of feasible SOUPs are typically defined within the sourcing opportunity utilization policies engine 208 (FIG. 2) by a user.

A review of this kind is frequently valuable due to complex relationships and interactions that exist between objectives for BPOTC and properties of the set of feasible SOUPs over which BPOTC is to be optimized. Due to these complex relationships and interactions, before completing an optimization, it is often difficult to anticipate how specific aspects of the set of feasible SOUPs and/or objectives for BPOTC may influence the characteristics of the optimal SOUP and the BPOTC it generates. As a result, it may be valuable to analyze one or more properties of the optimal SOUP, of the BPOTC which the optimal SOUP generates, and/or of constraints of the optimization problem that are (or are not) binding at an optimal solution in order to gain insight into how characteristics of the objectives for BPOTC and/or the set of feasible SOUPs may have influenced the optimal solution. This analysis may suggest that a revised version of objectives for BPOTC may more accurately reflect the business' goals and objectives, and/or that identification or negotiation of one or more modified or alternative sourcing opportunities may enable SOUPs to be constructed that better achieve objectives for BPOTC.

Thus in step 510, if the user desires to revise any aspects of the objectives for BPOTC, the method returns to step 502. Alternatively, if the user desires to revise the set of feasible SOUPs, then the method returns to step 504. For example, a review may be conducted of one or more of the properties of the optimal SOUP, the BPOTC that results from the “optimal” SOUP, and/or of the characteristics of the optimization problem itself with the “optimal” SOUP.

The user may continue to refine any and all of the inputs until the user is satisfied with the result. Accordingly, a final optimal SOUP is achieved. The user may refine objectives for BPOTC, for example, due to a change in the economy, a newly developed business model, a change in business circumstances or objectives, etc. One factor that may contribute to a decision to refine the objectives for BPOTC and/or the set of feasible SOUPs is the quantification of the BPTOC that results from the optimal SOUP. If the results are unsatisfactory, or the user merely wishes to see a different result, the objectives for BPOTC and/or the set of feasible SOUPs may be refined, or otherwise altered. This type of iteration builds the user's understanding of what is possible, and of the relationships and interactions between various aspects of the objectives for BPOTC and/or the set of feasible SOUPs and of the BPOTC of the resulting optimal SOUP, allowing for even further refinement.

Another factor that may contribute to refinement is a comparison of SOUPs and the BPOTC they generate. Impact of alternative SOUPs on the many dimensions of BPOTC, for example business performance under specific circumstances, such as high or low demand conditions, or circumstances in which supply is expensive or difficult to secure, may be considered. The impact may be studied in order to assist the user with refining objectives for BPOTC and/or the set of feasible SOUPs. Alternatively, the impact of alternative SOUPs may be studied in comparison with the optimal SOUP identified by the system and method of the present invention, with the user ultimately determining which policy and/or policies best achieves the user's overall business objectives and constraints.

In an embodiment of the present invention, a user may select a set of predetermined objectives for BPOTC. Accordingly, a user may utilize the inputs of previous users in order to achieve a similar objective or yield a similar result. For example, an impact of a specific objective for BPOTC for “A” is very positive and yielded excellent fulfillment of the business objective. “B” may have a similar objective and business type, goal, etc. and accordingly may choose to employ the same objective for BPOTC as “A” in hopes of attaining the same result. Alternatively, “B” may only need to refine particular aspects of the objective for BPOTC used by “A” in order to achieve a positive impact. Thus, the refinements and experience of previous users may assist users that follow in crafting their own objectives for BPOTC. The objectives for BPOTC of users and components thereof may be employed by subsequent users in any manner suitable for use with the present invention. This approach of seeing what previous users have done is useful in specifying objectives for BPOTC or the set of feasible SOUPS (in step 502 and 504). However, this approach does not apply to the optimization steps 508-510 since the optimal SOUP will always depend on both the specific objectives for BPOTC and the set of feasible SOUPs specified for the material(s) or service(s) in question.

Referring now to FIG. 6, steps for defining the set of feasible SOUPs (i.e., 504 of FIG. 5) is described in more detail. First, a range of sourcing opportunities available to the business for the material(s) or service(s) in question is identified in step 602. Typically, specific sourcing opportunities available to a business will depend on both characteristics of the material(s) or service(s) in question and characteristics of the business. Examples of business characteristics include, but are not limited to, overall size, credit quality, scale of the business' purchases of the materials or services in question, temporal pattern (e.g., seasonality) of the business' requirements, and geographic locations at which the materials or services are required. As noted above, the set of sourcing opportunities comprises a range of alternative types of supply agreements that may be established with one or more prospective suppliers or other prospective supply sources that may be available (e.g., spot markets, brokers, distributors), and a range of ways in which each such alternative may be utilized over time and across a range of circumstances that may occur.

The nature of the material(s) or service(s) in question typically impacts the nature of sourcing opportunities available in a number or ways. For example, material(s) or service(s) that is customized or semi-customized in nature is in many cases available only from one or a small number of suppliers. In contrast, material(s) and service(s) that is in broad use is often available from many suppliers, as well as frequently from distributors, brokers, and other forms of intermediaries, and in some cases through established trading markets. As a further example, complex materials with long manufacturing times, materials that rely on specialized capacity, or services that require specialized expertise or resources, may only be available at long lead times or in volumes limited by available capacity or appropriately skilled personnel.

Further, the characteristics of the purchasing business typically impacts both the nature of sourcing opportunities available and terms and conditions of those opportunities. For example, large purchasers of a material or service can often negotiate favorable terms (e.g., price, availability, payment terms, etc.) directly with key suppliers. In contrast, large suppliers may be unwilling to work directly with smaller purchasers, forcing the smaller purchasers to purchase from distributors or other forms of intermediaries, often on less desirable terms. As a second example, large purchasers, due to the volume of their requirements, may be exposed to greater risk of disruptions in availability of supply during upward fluctuations in their demand that result from capacity constraints. As a result, the large purchaser may either choose, or be required to enter into, supply agreements under which the purchaser assumes some or all costs and/or risks that one or more suppliers must incur in order to develop or maintain capacity and/or other capabilities capable of meeting the purchaser's potential requirements.

In many cases, including a majority of types of materials, services, and potential characteristics of a purchasing business, it is necessary for the purchasing business to engage in communication and/or negotiation with prospective supply providers in order to determine specific supply terms available to the business. These communications and negotiations commonly address prospective sourcing terms (e.g., quantities, lead times, inventories, pricing terms, volume discounts, flexibility premiums, payments, liabilities, penalties, incentives, etc.).

Because it is rarely practical or desirable to define and negotiate these terms for all prospective supply opportunities in advance, an iterative approach is applied. Under this approach, the buyer and/or one or more suppliers may initiate a discussion or negotiation around one or more specific sets of supply terms. These terms are then subsequently modified and refined based on feedback from, and negotiation with, the other party. The present invention contributes to the efficient management of this process and enables the quality of the supply terms under negotiation to be validated or improved. Specifically, the present invention may identify and analyze characteristics of the optimal SOUP from among a preliminary set of feasible SOUPs for a given set of objectives for BPOTC. The results of this analysis may then be used to guide subsequent negotiation and refinement of sourcing opportunities judged likely to enable the most valuable possible modifications or extensions of the set of feasible SOUPs.

In step 604, feasible SOUPs are represented analytically or mathematically so that the SOUPs can be incorporated in the optimization problem solved in step 506 (FIG. 5). Thus, the present invention must enable an accurate representation of all current and prospective sourcing opportunities for the material(s) or service(s) in question. This representation must include key terms and conditions for each sourcing opportunity including how the business may utilize the opportunity over a relevant time period and across a range of potential future circumstances that may occur. Additionally, since SOUP will generally draw on more than one such individual sourcing opportunity (e.g., sourcing from two different suppliers) or from more than one supply arrangement over time, the present invention must also enable combinations or “portfolios” of individual sourcing opportunities to be accurately represented. This representation step 604 will be discussed in more detail in connection with FIG. 7.

SOUPs may be specified in a number of ways such as direct specification. One exemplary method of specifying SOUPs involves a two step process. In the first step, the set or sourcing opportunities which the SOUP may draw on over time and across prospective future circumstances is specified, along with any constraints on joint use of, or interaction between, such sourcing opportunities. In a second step, a specific policy for utilizing this set of sourcing opportunities over time and across potential-future circumstances is specified. This exemplary method is referred to as a “functional” method since in many cases the set of feasible policies which may be selected in step 504 can be represented in mathematical or functional terms which define all of the feasible alternatives for utilizing the set of available sourcing opportunities. This method may facilitate optimization conducted in step 506 by enabling efficient representation of a set of feasible SOUPs and effective search of the feasible set by utilizing mathematical optimization techniques.

For example, a flexible quantity agreement in which a buyer commits to buying at least 100 units per month and receives rights without obligation to buy up to another 100 units per month may be represented functionally with a formula or constraint that restricts quantity ordered from a contract to a range of 100 to 200 units per month. As a second example, a business purchase contract that commits the buyer to either purchase 50 units per month or to pay a penalty of $1 for each unit not purchased can be represented with a function that defines purchase cost, number of units to be received, and penalty payment, if any, as a function of a number of units ordered, where the number of units ordered is constrained to a range of 0 to 50 units.

More generally, one SOUP may draw on one subset of available sourcing opportunities (e.g., flexible supply commitment with 1 year term followed by a fixed quantity supply commitment and a spot market source in a following year), while an alternative SOUP may draw on a different set of individual sourcing opportunities (e.g., distributor relationship for an entire length of the same two year period). In a further embodiment, two SOUPs may draw on exactly the same set of individual sourcing opportunities, buy may differ in how these opportunities are utilized over time. For example, one utilization policy (i.e., SOUP) for the distributor relationship indicated above may incorporate a substantial inventory buffer to guard against fluctuations in the distributor's price or availability, while another utilization policy may stipulate that no inventory be carried and that price and availability risk be managed by selecting fixed price and availability terms from the distributor. More generally, SOUPS may differ in both a set of sourcing opportunities they draw on over time and across future circumstances and in how they utilize such sourcing opportunities.

In general, if the set of feasible SOUPs is defined by fully specifying all feasible SOUPS, including how each of the sourcing opportunities drawn on by a SOUP is to be utilized over time and across prospective circumstances, search methods may be appropriate in step 506. Alternatively, if a “function representation” is utilized for one or more individual sourcing opportunities of for a definition of the set of feasible SOUPs, optimization methods may be more appropriate. In the later case, the policy for utilizing available sourcing opportunities over time and across prospective future circumstances which best achieves objectives for BPOTC may be determined as part of the optimization, eliminating the need to fully define and analyze a complete set of potential SOUPs that may exist for the set of available sourcing opportunities.

Referring to the first functional example above, an optimization may determine an optimal quantity in a feasible range of 100 and 200 units to purchase for each future period and set of prospective future circumstances directly, rather than evaluating all possible policies of this kind. Similar logic and optimization may be applied to all such decisions related to selection and utilization of individual sourcing opportunities.

Referring now to FIG. 7, an exemplary method for representing individual SOUPs and the set of feasible SOUPs is shown. The method for representing individual SOUPs and a set of feasible SOUPs comprises three steps. In step 702, representation of the individual sourcing opportunities for which specific values of all key terms are known is performed.

Typically, key business terms of specific sourcing opportunities (e.g., supply agreements, purchase from distributors or markets, etc.) comprise terms for price, quantity, lead time, payment, related business or financial commitments, liabilities, penalties, and other fees. For some sourcing opportunities (e.g., carefully structured supply contracts), each of these terms may be defined explicitly in advance. In other cases, some terms may not be fully defined in advance and actual outcomes may depend on uncertain future events. For example under sourcing from spot markets, future price and availability levels are typically uncertain. Uncertainty may also result, for example, when future price levels depend on a level of a pricing index or other variable basis when either lead time or availability levels are not explicitly defined or when there is risk that relevant suppliers may not perform to committed terms. Such uncertainty about one or more of these terms or about future performance of a supplier may also be represented, for example, by modeling the future values of the pricing index or a likely behavior of a supplier under relevant future circumstances.

Because a large number of key business terms are generally required to fully describe sourcing opportunities and the values of these terms may vary over time and/or by circumstances, an extremely large number of potential combinations of terms, and thus of specific sourcing opportunities, are possible. While for specific materials or services this number may be more limited, the representation of individual sourcing opportunities must be a broadest possible range of all potential sourcing opportunities represented in an efficient manner. However, a system based on a list or menu, for example, from which users may select an appropriate representation of a specific sourcing opportunity of interest may not be practical due to the large number of alternatives that would have to be included in the list or menu.

One efficient solution for representing a large number or prospective sourcing alternatives is a building block approach. Under this embodiment, lists, menus, or other forms of access and representation are created for each key category of terms that may be required to represent a sourcing opportunity (e.g., price terms, quantity terms, etc.). Once each key category of terms is entered, the present invention constructs a complete representation of the sourcing opportunity. Subsequently, the representation's “building block” structure enables a user to easily modify individual terms or categories of terms of the representation. Further, users may also easily create representations of similar or related sourcing opportunities by copying and modifying appropriate terms of an existing representation of a similar sourcing opportunity.

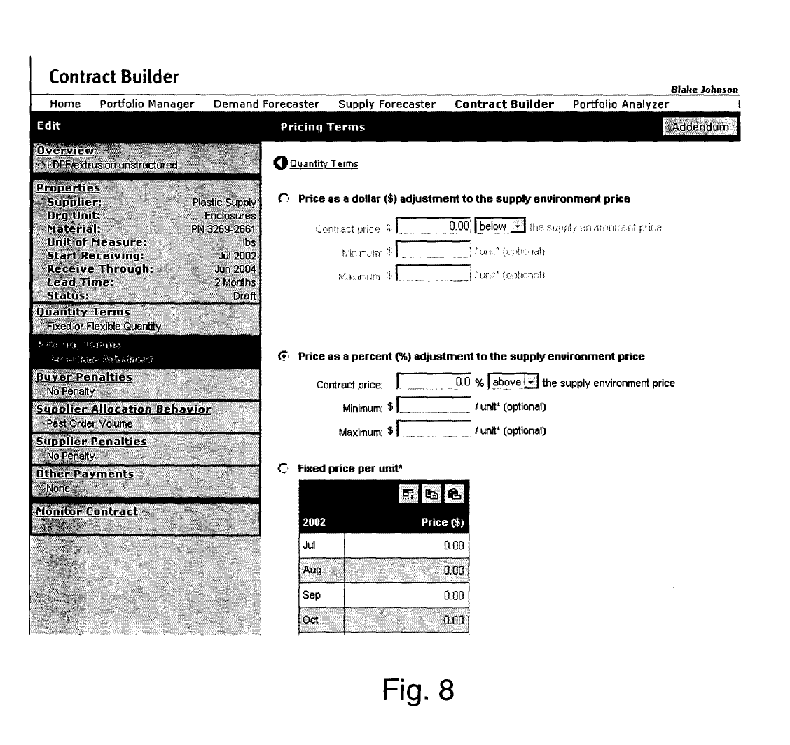

Thus, this building block embodiment facilitates the task of representing sourcing opportunities and of subsequently reviewing or updating such representations. Since the menus or templates only address components of an overall sourcing opportunity, these menus or template can be focused and tailored. An exemplary embodiment of a template for “pricing” terms of a sourcing opportunity is shown in FIG. 8.

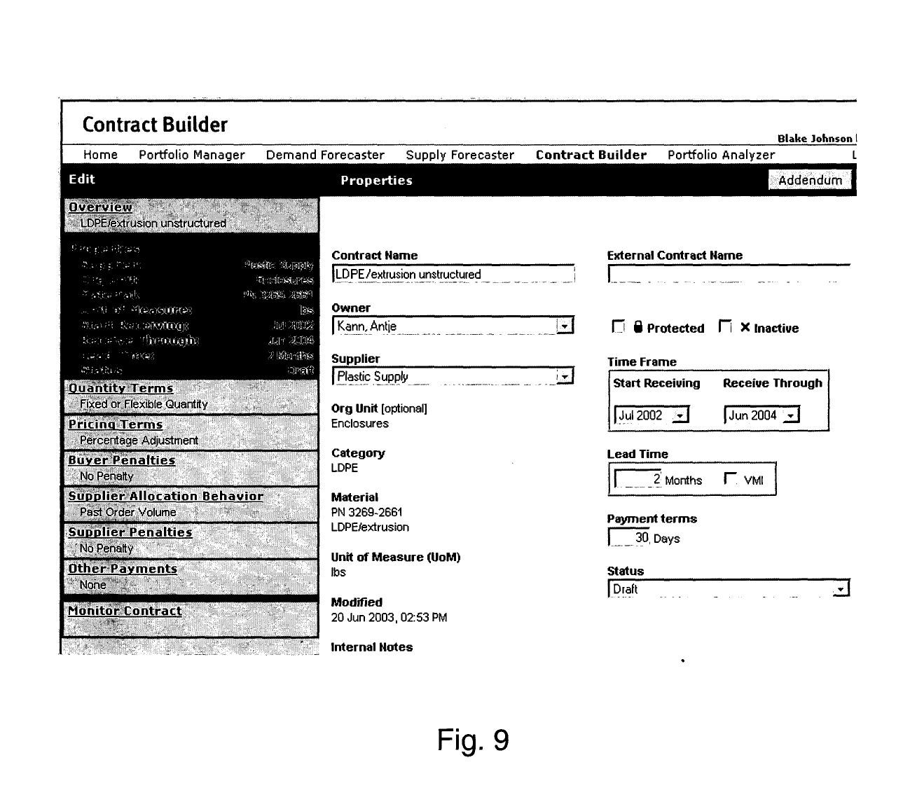

Additionally, a higher level menu or process template can be constructed which lists, and may provide direct access to, the menu or templates for each potential element or “building block” of the overall representation of a sourcing opportunity. A high level menu or template of this kind facilitates the construction, and potential subsequent modification, of the representation of a sourcing opportunity. An exemplary embodiment of such a “high level” menu is shown in FIG. 9. Further, this embodiment draws the user's attention to a full list of elements that may be necessary or appropriate to effectively represent a sourcing opportunity. This increases the likelihood that a sourcing opportunity will be appropriately specified and represented. Without such a system, for example, a user may define and represent price, quantity, and lead time terms of a sourcing opportunity, but may fail to consider or to record other terms (e.g., terms that only become relevant in an event that certain contingencies occur such as penalty or liability terms).

Next in step 704, representation of estimated terms (where specific values are unknown) of individual sourcing opportunities that may be available is performed. It is useful to represent the estimated terms of sourcing opportunities that may be available now or at future points in time under a range of prospective circumstances that may prevail at those points in time. It may be desirable to estimate terms of sourcing opportunities that may be available now, as previously discussed, in order to assess the business impact and value of prospective sourcing opportunities before conducting communications and negotiations with prospective sources of supply in order to fully define actual terms for such opportunities. This may be true, for example, because the process of communication and negotiation may be time consuming and costly. Further, a business may not want to share structure or terms of one or more sourcing opportunities with a prospective supplier during a preliminary assessment. Similarly, suppliers may have concerns about entering into discussions about terms of a sourcing opportunity for which a buyer's level of interest is viewed as preliminary or otherwise exploratory or non-committal.

Further, it may be desirable to estimate terms of sourcing opportunities that may be available at future points in time including across alternative sets of prospective future circumstances which may prevail at those times. Estimated terms, rather than fully specified terms, are likely to be required in most cases for prospective future sourcing opportunities for two primary reasons. First, significant additional complexity associated with attempting to fully anticipate all business factors and other considerations likely to prevail at future points in time and under alternative sets of prospective future circumstances exists for both buyers and suppliers. This additional complexity greatly increases a number of sourcing opportunities and terms that may need to be specified, and may resultantly be viewed as inefficient or speculative. Secondly, discussing or negotiating terms for prospective future sourcing opportunities may raise buyer and/or supplier concerns about excessive, unnecessary, or premature disclosure of valuable information about future expectations, business objectives, negotiation position, strategy, etc.

The estimated terms of prospective sourcing opportunities, including alternatives that may be available now and those that may be available at future points in time, may be represented utilizing the same system and method described above for representing sourcing opportunities with defined terms (step 702). However, because a complete set of specific terms is not yet available, it may be useful to generate representations of a set of prospective sourcing opportunities. Together, the representations of the set may span a spectrum of terms viewed as plausible and relevant to business considerations at hand. For example, it may be useful to represent the set of sourcing opportunities that may be available at a future point in time using a set of prospective sourcing opportunities where the pricing terms of the specific sourcing opportunities in this set range from probable lowest to highest price levels at that time. It may further be useful to estimate relative likelihood or probability of each price level, and accordingly of the sourcing opportunity that represents each price level.

Next in step 706, the SOUPs are represented as feasible combinations. Once the range of potential individual sourcing opportunities have been represented, including both estimated (step 704) and fully defined (step 702) sourcing alternatives, these representations may be used to construct representations of SOUPs.

As previously discussed, a SOUP specifies how an available set of sourcing opportunities is utilized over time. When there is uncertainty about one or more relevant future circumstances, the specification of the SOUP must define how an available set of sourcing opportunities should be utilized under each relevant set of potential future circumstances, for example prospective future demand, price, or supplier performance levels. Accordingly, while a SOUP may be specified directly, it is frequently useful, as in the present invention, to generate the representation of a SOUP using a two step process. In the first step, the set of sourcing opportunities which the SOUP may draw on over time is specified. Next in the second step, how this set of sourcing opportunities will be utilized over time and across potential future circumstances is specified.

In one embodiment of the present invention, this two step process is used to define the set of feasible SOUPs in step 504 (FIG. 5) to be considered in the optimization conducted in step 506 (FIG. 5). This set of potential SOUPs is defined by identifying all possible methods of utilizing the set of available sourcing opportunities over time and across potential future circumstances.

For example one SOUP may draw on one set of individual sourcing opportunities, composition of which may vary over time and across future circumstances, while an alternative SOUP may draw on a different set of individual sourcing opportunities over time and across future circumstances. Alternatively, two SOUPs may draw on exactly the same set of individual sourcing opportunities over time and across future circumstances, but may differ on how these opportunities are utilized over time. More generally, SOUPs may differ in both the set of sourcing opportunities they draw on over time and across future circumstances, and in how the SOUPs utilize such sourcing opportunities.

Referring back to steps 508-510 of FIG. 5, results of the optimization may be analyzed to gain insights that may enable further improvements in sourcing performance through subsequent refinement of the objectives for BPOTC or the set of feasible SOUPS. Analysis may be conducted, for example, of properties of the optimal SOUP, of the BPOTC it generates, of their relationships and interactions, and of constraints of the optimization problem.

In one embodiment, a range of insights may be generated through analysis of the properties of the optimal SOUP. For example, the business may wish to review which one or more individual sourcing opportunities are utilized by the optimal SOUP, including, how this set of utilized sourcing opportunities varies over time and across alternative prospective future circumstances.

By conducting such a review a business may discover, for example, that substantially different sourcing opportunities are utilized at different stages in a lifecycle of one or more products in which the material(s) or service(s) being sourced are utilized, or under different supply market conditions. For example, when sourcing a commodity material, it may be optimal to utilize short term or market-based sourcing opportunities at points in the market cycle during which there is an excess supply of the material, and to utilize structured contracts with defined and committed price and availability terms at points in the market cycle when the material is in short supply. Further, because uncertainty commonly exists about the specific market conditions that will prevail over time and across prospective future circumstances, sourcing opportunities that enable the business to hedge against such uncertainty (e.g., price caps or guaranteed availability commitments) may also be incorporated.

As a second example, the optimal SOUP may utilize sourcing opportunities with quite different characteristics at different stages in a product's lifecycle. For example, a business may utilize flexible supply agreements to assure availability of supply across a range of potential demand levels believed to be possible during a highly uncertain initial launch period of a product. Next, during a “mature” or high volume stage of the product's lifecycle, the business may emphasize sourcing opportunities that enable the business to maximize gross margin by minimizing purchase price. Finally, during the product's “end of life” period, the business may utilize sourcing opportunities that provide flexibility in quantity supplied and minimal liability in order to minimize exposure to “end of life” inventory risk.

In both examples above, the insights generated by analysis of the optimal SOUP may enable the business to realize further value by negotiating additional or revised sourcing opportunities with terms tailored to enable further improvement in the performance of a specific type of SOUP identified to be optimal. For example, in the second case above, the business may be able to utilize insights gained through analysis of the optimal SOUP to negotiate sourcing opportunities with suppliers that span two or more stages of the product lifecycle, and have terms tailored to each stage. This enables the business to realize greater value by matching terms of its supply resources to its requirements over the product lifecycle. This also enables the firm's suppliers to plan and execute their activities more effectively by providing them with additional information and business commitments about the business' sourcing objectives and requirements over the product lifecycle. Thus, analysis of the optimal SOUP may provide information useful to the further development of specific types of sourcing opportunities likely to enable improved performance to the firm's objectives for BPOTC, including, sourcing opportunities matched to specific periods of time and prospective future circumstances.

In a third example, analysis of one or more individual sourcing opportunities utilized over time by the optimal SOUP may reveal flaws in the specification or representation of one or more of the sourcing opportunities, in the constraints imposed on how the sourcing opportunities may be utilized jointly, or in their interactions. For example, analysis of the optimal SOUP may reveal that the SOUP relies on sourcing large volumes from a spot market or distributor that is, in fact, known to only be able to supply small volumes. Alternatively, the analysis may reveal that the SOUP incorporates sudden or frequent switches between sourcing from two or more different supply sources in a manner not feasible or desirable. Insights of this kind may be utilized to revise the representation of the individual sourcing opportunities, and/or of the constraints on, or interactions between, the utilization of two our more individual sourcing opportunities.

A second potential area of analysis of the optimal SOUP is of how one or more of the sourcing opportunities upon which the optimal SOUP draws are utilized including, analysis of such utilization policies over time and across prospective future circumstances. For example, an optimal SOUP may utilize one or more sourcing opportunities to build a substantial buffer stock of inventory in advance of a projected seasonal increase in demand, or of an anticipated increase in the price of, or decrease in availability of, supply. If such an inventory strategy is identified as a component of an optimal SOUP, before implementation of the SOUP the business may wish to inform relevant decision makers to confirm consistency with the business' objectives for BPOTC. The business may also wish to inform such a review with results of further analysis of the optimal SOUP conducted to determine whether cost and availability benefits of a strategy do in fact more than offset risks and potential negative perceptions, both within the business and externally, that may accompany a large inventory position. For example, the business may wish to re-run optimization one or more times after adding additional constraints on maximum acceptable inventory levels at one or more points in time. Doing so may enable the business to better understand relationships between inventory buffer size and other related dimensions of BPOTC, enabling management to make a more fully informed decision.

As a second example of analysis of optimal SOUP, the optimal SOUP may utilize multiple sourcing opportunities with different lead times and/or which have different pricing terms (e.g., fixed prices, variable prices, and price caps, etc.) in a manner that optimizes sourcing to best meet the business' objectives for BPOTC. Due to complex interactions between many possible ways to utilize multiple sourcing opportunities of this kind and BPOTC, particularly when future demand, price, or other variables are uncertain, analysis of the utilization policies of the optimal SOUP may provide insights that enable refinements or other improvements in terms of relevant sourcing opportunities. For example, analysis of this kind may reveal that a sourcing opportunity with a longer lead time and lower price but specified maximum available quantity is being fully utilized, while one or more other sourcing opportunities with shorter lead times and higher prices are being utilized at levels significantly below available volumes. Based on this information, the business may, for example, assess whether objectives for BPOTC can be better met by negotiating an increase in quantity available from longer lead time, lower price source of supply and a decrease in committed volume of one or more of shorter lead time, or higher price sources of supply.

A similar process of assessment of one or more characteristics of the BPOTC generated by the optimal SOUP may be followed. As true for the assessment of one or more of the characteristics of the optimal SOUP, the goal of such an assessment is to provide additional insights that may enable valuable modifications in the set of feasible SOUPs and/or objectives for BPOTC. For example, a business may wish to review absolute performance or relative performance, including probability distributions or risk levels, of individual performance metrics of the BPOTC generated by the optimal SOUP, such as price, inventory, service level, etc., at individual points in time, under specific prospective future circumstances, cumulatively over a period of time, etc.

In one such example, a business' specification of its objectives for BPOTC may include an objective of minimizing expected price per unit. Upon assessing a price performance component of a BPOTC generated by an optimal SOUP, the business may be satisfied with an average price per unit obtained, but may, for example, identify one or more periods in time or sets of circumstances under which very high prices are paid. If this is viewed as infeasible or undesirable, the business may choose to alter its objectives for BPOTC, for example to include a cap on the price it is willing to pay or a performance penalty incurred if high prices are paid. Alternatively, the business may seek to renegotiate, modify, or otherwise alter a set of available sourcing opportunities to incorporate price caps or other forms of protection against high prices. Lastly, the business may choose to combine one or more revisions in its objectives for BPOTC with one or modifications in the set of available sourcing opportunities.

As a second example of how businesses may evaluate BPOTC generated by the optimal SOUP, the business may wish to review relative performance across multiple metrics (e.g., cost vs. service level vs. inventory, at individual points in time, under specific prospective future circumstances, cumulatively over a period of time, etc.). Continuing the example above in which the price component of BPOTC was assessed, the business may further determine that its objective of minimizing expected per unit price has also resulted in purchases from suppliers with longer lead times and poorer quality, resulting in increased inventory levels and reductions in customer service levels. As a result, the business may choose to alter its objectives for BPOTC to add or place further emphasis of performance dimensions such as quality, lead time, or inventory level.

As a third example, if one or more constraints are included in the business' objectives for BPOTC, the business may wish to assess when, and under what circumstances, these constraints are or are not binding. For instance, returning to the example above, assume that in a first revision of its objectives for BPOTC the business chooses to incorporate a constraint that limits inventory to levels at or below a specified maximum. After determining the optimal SOUP for this revised specification of objectives for BPOTC, the business may evaluate whether, and under what circumstances, this constraint is binding under the BPOTC generated by the optimal SOUP. The business may further wish to assess whether increased cost or decreased service levels result when the constraint is binding, whether analysis of other dimensions of BPOTC suggest an overall improvement in BPOTC has been achieved, or whether further alterations in the objectives for BPOTC, and/or in the set of feasible SOUPs may merit analysis.

As suggested above, it may also be desirable to assess the optimal SOUP and the BPOTC it generates, jointly, for example, to evaluate interactions and relationships between them, and/or to modify both the objectives for BPOTC and the set of feasible SOUPs before returning to the optimization step 506 (FIG. 5). Jointly evaluating and/or modifying objectives for BPOTC and the set of feasible SOUPs may be valuable due to close interactions and relationships between the objectives for BPOTC and the set of feasible SOUPs. For example, new insights into how the specification of objectives for BPOTC may be refined to more accurately represent a business' specific objectives for BPOTC, such as limiting exposure to high prices in the example above, may also suggest potentially valuable modifications or extensions of the set of feasible SOUPs, such as price caps or other related terms of feasible SOUPs that provide protection against high prices.

In summary, assessment of the optimal SOUP, the BPOTC it generates, the constraints of the optimization problem at the optimal SOUP, or other related forms of analysis of the solution to the optimization conducted step 506 (FIG. 5), may enable refinement of either or both the specification of the firm's objectives for BPOTC and the set of feasible SOUPs. The opportunity to improve the quality of the final optimal SOUP and associated BPOTC it generates by utilizing such a process may in fact be quite significant, due to the complexity of the objectives for BPOTC and the set of feasible SOUPs individually, and of their relationships and interactions jointly. Thus a further contribution of the system and method disclosed here, in addition to enabling the optimal SOUP for a specific set of objectives for BPOTC and a set of feasible SOUPs to be identified, is the ability to enable further improvements in the BPOTC ultimately achieved by iteratively refining the firm's specified objectives for BPOTC and/or set of feasible SOUPs based on analysis of the results of the optimal SOUPs and associated BPOTC generated by prior specifications.

The invention has been described above with reference to specific embodiments. It will be apparent to those skilled in the art that various modifications may be made and other embodiments can be used without departing from the broader scope of the invention. For example, any data described as being user-input may actually be fed from another source such as on-line data from the Internet or another supplied database. Therefore, these and other variations upon the specific embodiments are intended to be covered by the present invention.

What is claimed is:

1. A system for optimizing sourcing opportunity utilization policies comprising:
a sourcing opportunity utilization policies engine configured for providing sourcing opportunity utilization polices;
a cost/risk generator configured for computing sourcing performance by utilizing the sourcing opportunity utilization policies from the sourcing opportunity utilization policies engine; and
an optimization engine configured for comparing the sourcing performance from the cost/risk generator to at least one objective for business performance over time and across potential future circumstances to determine an optimal sourcing opportunity utilization policy.

2. The system of claim 1 wherein the sourcing opportunity utilization policies engine is further configured to develop the sourcing opportunity utilization policies.

3. The system of claim 1 wherein the sourcing opportunity utilization policy engine is further configured to allow revision to a set of feasible sourcing opportunity policies.

4. The system of claim 1 wherein the optimization engine is further configured to allow revision to the at least one objective to further refine the optimal sourcing opportunity utilization policy.

5. A method for optimizing sourcing opportunity utilization policies comprising:
receiving at least one objective for business performance over time and across potential future circumstances;
defining a set of feasible sourcing opportunity utilization policies;
utilizing the set of feasible sourcing opportunity utilization policies to perform sourcing performance analysis; and
evaluating sourcing performance analysis results to determine the optimal sourcing opportunity utilization policy.

6. The method of claim 5 further comprising revising the set of feasible sourcing opportunity policies and performing sourcing performance analysis with the revised set of feasible sourcing opportunity utilization policies.

7. The method of claim 5 further comprising revising the at least one objective for business performance over time and across potential future circumstances and performing sourcing performance analysis with the revised at least one objective.

8. The method of claim 5 wherein the evaluating occurs in an optimization engine.

9. The method of claim 5 wherein defining the set of feasible sourcing opportunity utilization policies further comprises utilizing a predefined sourcing opportunity utilization policy.

10. The method of claim 5 wherein defining the set of feasible sourcing opportunity utilization policies further comprises providing a listing of key terms for sourcing opportunities from which a user may select.

11. The method of claim 5 wherein defining the set of feasible sourcing opportunity utilization policies further comprises identifying a range of prospective sourcing opportunities.

12. The method of claim 5 wherein defining the set of feasible sourcing opportunity utilization policies further comprises representing feasible sourcing opportunity utilization policies analytically.

13. The method of claim 5 wherein receiving at least one objective further comprises utilizing a predefined objective for business performance over time and across potential future circumstances.

14. The method of claim 5 wherein receiving at least one objective further comprises providing a listing of key terms for the at least one objective from which a user may select.

15. A machine readable medium having embodied thereon a program being executable by a machine to perform a method for optimizing sourcing opportunity utilization policies, the method comprising:
receiving at least one objective for business performance over time and across potential future circumstances;
defining a set of feasible sourcing opportunity utilization policies;
utilizing the set of feasible sourcing opportunity utilization policies to perform sourcing performance analysis; and
evaluating sourcing performance analysis results to determine the optimal sourcing opportunity utilization policy.

16. A system for optimizing sourcing opportunity utilization policies comprising:
means for receiving at least one objective for business performance over time and across potential future circumstances;
means for defining a set of feasible sourcing opportunity utilization policies;
means for utilizing the set of feasible sourcing opportunity utilization policies to perform sourcing performance analysis; and
means for evaluating sourcing performance analysis results to determine the optimal sourcing opportunity utilization policy.

17. A method for analytically representing sourcing opportunity utilization policies comprising:
representing specific individual sourcing opportunities for which specific values of all key terms are known;
representing estimated terms of indefinite individual sourcing opportunities for which specific values of one or more key terms are not known; and
representing sourcing opportunity utilization policies as a combination of the specific individual sourcing opportunities and indefinite individual sourcing opportunities.

18. The method of claim 17 wherein representing specific individual sourcing opportunities further comprises providing a listing of key terms for sourcing opportunities from which a user may select.

19. The method of claim 17 wherein representing estimated terms of indefinite individual sourcing opportunities further comprises providing a listing of key terms for sourcing opportunities from which a user may select.

20. A machine readable medium having embodied thereon a program being executable by a machine to perform a method for analytically representing sourcing opportunity utilization policies comprising:
representing specific individual sourcing opportunities for which specific values of all key terms are known;
representing estimated terms of indefinite individual sourcing opportunities for which specific values of one or more key terms are not known; and
representing sourcing opportunity utilization policies as a combination of the specific individual sourcing opportunities and indefinite individual sourcing opportunities.
